(19) United States
(12) Patent Application Publication
(10) Pub. No.: US 2026/0024971 A1
(43) Pub. Date: Jan. 22, 2026

(54) CORRUGATED TUBE HOLDING STRUCTURE AND ELECTRIC WIRE PROTECTION COMPONENT

(71) Applicant: Yazaki Corporation, Tokyo (JP)

(72) Inventors: Kaoru SAWAIRI, Shizuoka (JP); Tohru KUROSAWA, Shizuoka (JP)

(73) Assignee: Yazaki Corporation, Tokyo (JP)

(21) Appl. No.: 19/240,537

(22) Filed: Jun. 17, 2025

(30) Foreign Application Priority Data
Jul. 18, 2024 (JP) 2024-114528

(51) Int. Cl. H02G 3/06; H02G 3/04

(52) U.S. Cl. CPC H02G 3/0691; H02G 3/0418; H02G 3/0468

(57) ABSTRACT

A pair of holding members of a corrugated tube holding structure includes holding portions that sandwich and hold the terminal of the corrugated tube at an outer peripheral face. The pair of holding portions includes holding ribs provided with semi-arcuate portions concentrically inserted into the valley portions at the outer peripheral face, the holding rib being a protrusion protruding from the inner wall face for each valley portions of the corrugated tube toward the outer peripheral face. One of the holding portions has a pair of deformation restrainers that protrudes from the inner wall faces of the holding portion and suppresses radially inward deformation of the terminal of the corrugated tube. Each of the deformation restrainers has a locking portion inserted into the valley portion of the terminal of the corrugated tube toward the inner peripheral face and locks radially inward movement of the terminal of the corrugated tube.

### CROSS-REFERENCE TO RELATED APPLICATION(S)

The present application claims priority to and incorporates by reference the entire contents of Japanese Patent Application No. 2024-114528 filed in Japan on Jul. 18, 2024.

### BACKGROUND OF THE INVENTION

### 1. Field of the Invention

The present invention relates to a corrugated tube holding structure and an electric wire protection component.

### 2. Description of the Related Art

In the related art, an electric wire protection component includes a housing and a cover that accommodate a plurality of electric wires pulled out from a terminal of a circular tubular corrugated tube and pull out the plurality of electric wires. The housing and the cover include holding ribs for holding the terminal of the corrugated tube. Each of the holding ribs has a semi-arcuate portion forming an arc portion when the housing and the cover are in an assembled state, and the terminal of the corrugated tube is held by inserting the semi-arcuate portion into a valley portion of a bellows portion of the corrugated tube (Refer to Japanese Patent Application Laid-open No. JP 2018-164 390 A). In the conventional corrugated tube holding structure using a slit-formed corrugated tube, when the corrugated tube is pulled in the tube axis direction and the side wall face of the valley portion is caught by the holding rib, the corrugated tube is narrowed radially inward to reduce a hooking margin of the holding rib in the valley portion. Therefore, the conventional corrugated tube holding structure may lower the holding force of the corrugated tube, and there is room for improvement in this respect.

### SUMMARY OF THE INVENTION

Therefore, an object of the present invention is to provide a corrugated tube holding structure and an electric wire protection component capable of suppressing a decrease in the holding force of a corrugated tube.

In order to achieve the above mentioned object, a corrugated tube holding structure according to one aspect of the present invention includes a pair of holding members that holds a terminal of a corrugated tube in an assembled state, wherein the corrugated tube is formed in a bellows tube shape having annular valley portions and crest portions alternately disposed in a tube axis direction, and a slit cut in the tube axis direction, the pair of holding members includes holding portions that sandwich and hold the terminal of the corrugated tube at an outer peripheral face of the corrugated tube, the pair of holding portions includes holding ribs provided with semi-arcuate portions concentrically inserted into the valley portions at the outer peripheral face, the each holding rib being a protrusion protruding from an inner wall face toward the outer peripheral face for each of the plurality of valley portions, one of the holding portions includes a pair of deformation restrainers that protrudes from the inner wall face and suppresses radially inward deformation of the terminal of the corrugated tube, each of the deformation restrainers includes a locking portion that is inserted into the valley portion of the terminal of the corrugated tube at an inner peripheral face and locks radially inward movement of the terminal of the corrugated tube in the valley portion, and the locking portions of the pair of deformation restrainers are disposed to face each other in a direction orthogonal to the tube axis direction.

In order to achieve the above mentioned object, an electric wire protection component according to another aspect of the present invention includes a corrugated tube having annular valley portions and crest portions alternately disposed in a tube axis direction, and a slit cut in the tube axis direction, the corrugated tube having a bellows tube shape through which a plurality of electric wires is inserted; a housing that accommodates the plurality of electric wires pulled out from a terminal of the corrugated tube and pulls the plurality of electric wires outward; and a cover that holds the terminal of the corrugated tube with the housing in an assembled state and covers the plurality of electric wires pulled out from the terminal of the corrugated tube with the housing in the assembled state, wherein the housing and the cover include holding portions that sandwich and hold the terminal of the corrugated tube at an outer peripheral face of the corrugated tube, the pair of holding portions includes holding ribs provided with semi-arcuate portions concentrically inserted into the valley portions at the outer peripheral face, the each holding rib being a protrusion protruding from an inner wall face toward the outer peripheral face for each of the plurality of valley portions, one of the holding portions includes a pair of deformation restrainers that protrudes from the inner wall face and suppresses radially inward deformation of the terminal of the corrugated tube, each of the deformation restrainers includes a locking portion that is inserted into the valley portion of the terminal of the corrugated tube at an inner peripheral face and locks radially inward movement of the terminal of the corrugated tube in the valley portion, and the locking portions of the pair of deformation restrainers are disposed to face each other in a direction orthogonal to the tube axis direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view illustrating a corrugated tube holding structure and an electric wire protection component according to an embodiment;

FIG. 2 is a perspective view illustrating a corrugated tube holding structure and an electric wire protection component according to the embodiment;

FIG. 3 is a cross-sectional view taken along line X-X of FIG. 2;

FIG. 4 is a partially enlarged view taken along line Y-Y in FIG. 2;

FIG. 5 is a partially enlarged view taken along line Z-Z in FIG. 2;

FIG. 6 is a perspective view illustrating a main part of the inside of the housing;

FIG. 7 is a plan view illustrating a main part of the inside of the housing;

FIG. 8 is a plan view illustrating a main part of the inside of the cover;

FIG. 9 is an explanatory view for describing the start of assembling the corrugated tube; and

FIG. 10 is an explanatory view for describing the end of assembling the corrugated tube.

### DETAILED DESCRIPTION OF THE PREFERRED EMBODIMENTS

Hereinafter, embodiments of a corrugated tube holding structure and an electric wire protection component according to the present invention will be described in detail with reference to the drawings. Note that the present invention is not limited by the embodiment.

### Embodiments

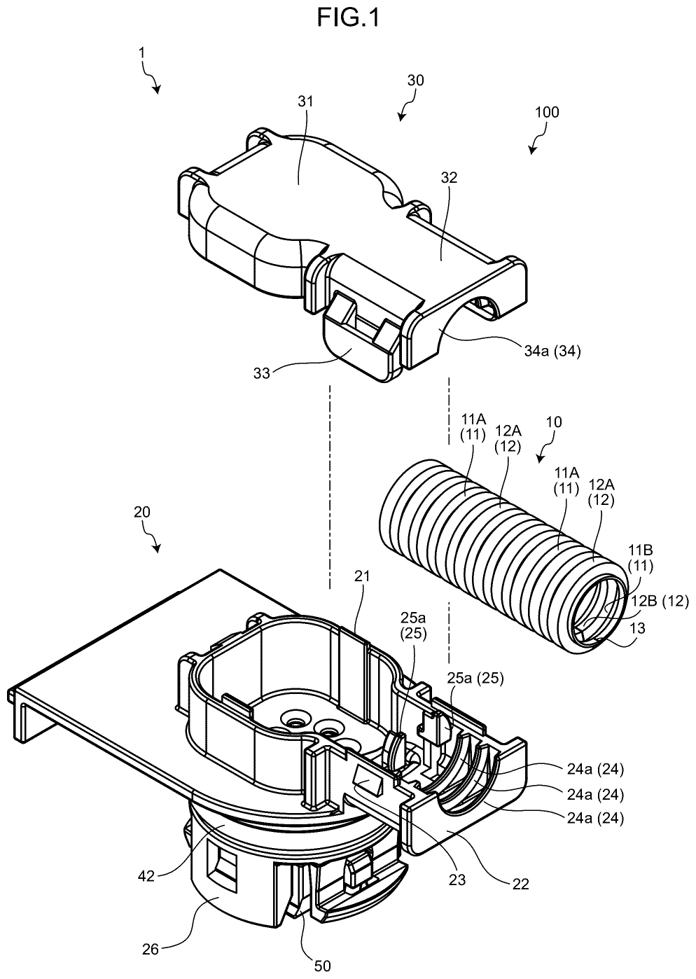

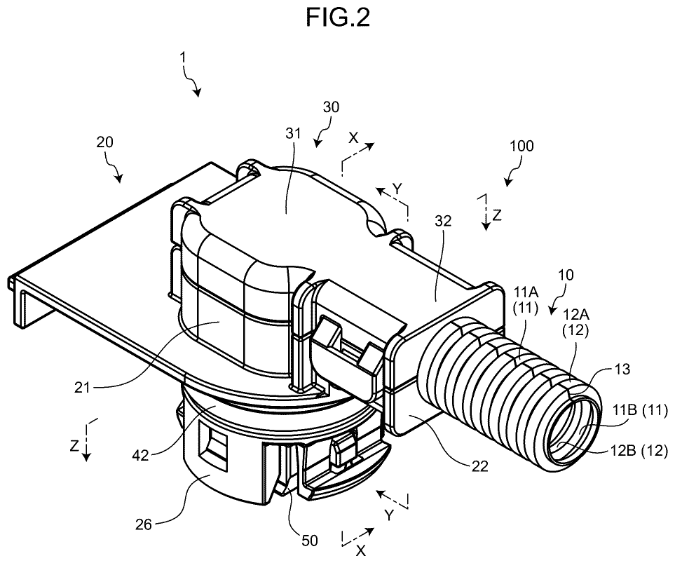

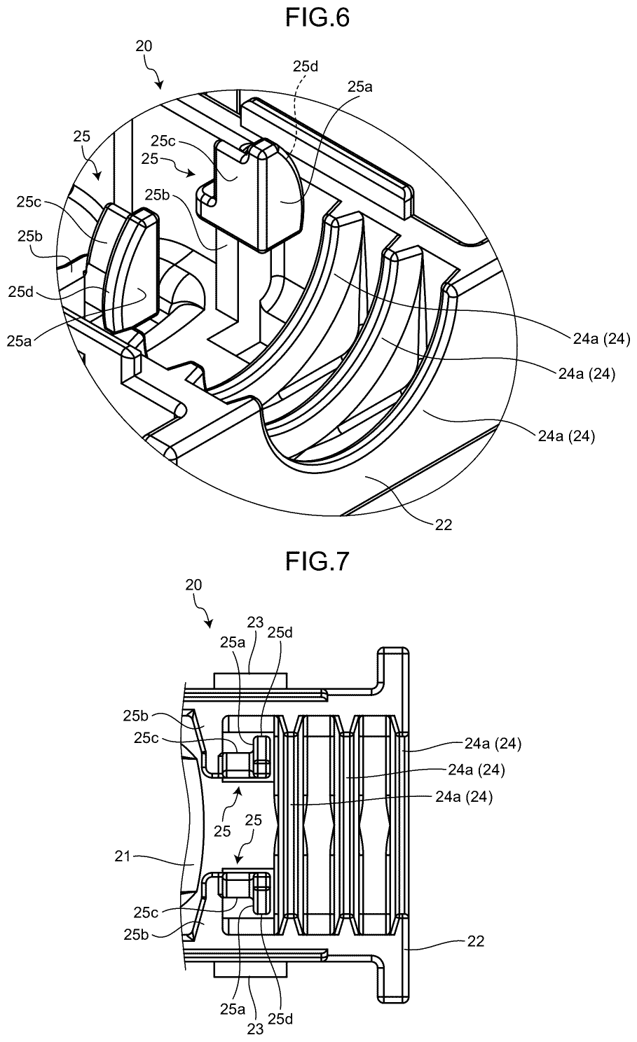

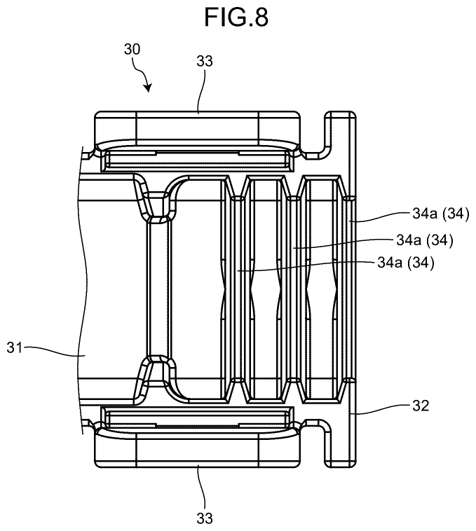

One of embodiments of a corrugated tube holding structure and an electric wire protection component according to the present invention will be described with reference to FIGS. 1 to 10.

Reference numeral 1 in FIGS. 1 to 5 indicates the electric wire protection component of the present embodiment. An electric wire protection component 1 includes a circular tubular corrugated tube 10, and a housing 20 and a cover 30 as a pair of holding members that hold a terminal of a corrugated tube 10 in an assembled state (FIGS. 1 to 5). A corrugated tube holding structure 100 of the present embodiment includes the housing 20 and the cover 30 as a pair of holding members.

The corrugated tube 10 is formed in a bellows tube shape having annular valley portions 11 and crest portions 12 alternately disposed in the tube axis direction and a slit 13 cut in the tube axis direction (FIGS. 1 to 5). In the corrugated tube 10, a valley portion 11A at the outer peripheral face is a crest portion 12A when viewed from the inner peripheral face side, and a crest portion 12B at the outer peripheral face is a valley portion 11B when viewed from the inner peripheral face side. A plurality of electric wires (not illustrated) is inserted into the corrugated tube 10.

The housing 20 and the cover 30 as a pair of holding members are formed of an insulating material such as a synthetic resin, and are assembled to each other.

The housing 20 accommodates and pulls out a plurality of electric wires pulled out from the terminal of the corrugated tube 10. The cover 30 holds the terminal of the corrugated tube 10 with the housing 20 in the assembled state, and covers the plurality of electric wires pulled out from the terminal of the corrugated tube 10 with the housing 20 in the assembled state.

The housing 20 includes a housing body 21 that accommodates a plurality of electric wires pulled out from the terminal of the corrugated tube 10 (FIGS. 1 to 5). The cover 30 includes a cover body 31 that covers the plurality of electric wires pulled out from the terminal of the corrugated tube 10 with the housing 20 in the assembled state (FIGS. 1 to 4). The housing body 21 and the cover body 31 form an internal space in which a plurality of electric wires pulled out from the terminal of the corrugated tube 10 are routed when the assembly is completed.

The housing 20 and the cover 30 have holding portions 22 and 32 that sandwich and hold the terminal of the corrugated tube 10 at the outer peripheral face (FIGS. 1 to 4).

The assembled state with the housing 20 and the cover 30 is maintained by a plurality of lock mechanisms. The lock mechanism keeps the assembled state by engaging a first engagement portion 23 provided in the housing 20 and a second engagement portion 33 provided in the cover 30 with each other in the assembled state (FIGS. 1 and 3 to 5). For example, in the lock mechanism, the first engagement portion 23 is formed as a claw-shaped protrusion, and the second engagement portion 33 is formed as a groove in which the protrusion is hooked. One lock mechanism is provided between the housing body 21 and the cover body 31, and two lock mechanisms are provided between the pair of holding portions 22 and 32.

The pair of holding portions 22 and 32 has a tubular shape in the assembled state, and holds the terminal of the corrugated tube 10 inside thereof. The pair of holding portions 22 and 32 is a protrusion protruding from the inner wall face for each of the plurality of valley portions 11A at the outer peripheral face of the corrugated tube 10, and includes holding ribs 24 and 34 that enter the valley portions 11A to hold the terminal of the corrugated tube 10 (FIGS. 1, 3, and 5 to 8). The pair of holding ribs 24 and 34 is provided with semi-arcuate portions 24a and 34a concentrically inserted into the plurality of valley portions 11A at the outer peripheral face of the corrugated tube 10 (FIGS. 1, 3, 7, and 8). The pair of semi-arcuate portions 24a and 34a forms an annular portion when the pair of holding portions 22 and 32 is in the assembled state, and is disposed concentrically in the valley portions 11A. Therefore, the pair of semi-arcuate portions 24a and 34a can lock the side wall face of the valley portion 11A of the corrugated tube 10 in the tube axis direction. Therefore, the terminal of the corrugated tube 10 is held by the plurality of pairs of holding ribs 24 and 34 of the pair of holding portions 22 and 32.

As described above, when the corrugated tube 10 is pulled in the tube axis direction as it is, the side wall face of the valley portion 11A is caught by the semi-arcuate portions 24a and 34a of the pair of holding ribs 24 and 34, and the corrugated tube 10 is narrowed radially inward, so that the hooking margin of the semi-arcuate portions 24a and 34a in the valley portion 11A is reduced.

Therefore, the one holding portion 22 (32) includes a pair of deformation restrainers 25 that protrudes from an inner wall face thereof and suppresses radially inward deformation of the terminal of the corrugated tube 10 (FIGS. 1 and 3 to 7). Here, the holding portion 22 of the housing 20 includes the deformation restrainer 25.

The deformation restrainer 25 includes a locking portion 25a that is inserted into the valley portion 11B of the terminal of the corrugated tube 10 at the inner peripheral face, and locks radially inward movement of the terminal of the corrugated tube 10 in the valley portion 11B (FIGS. 1 and 3 to 7). The respective locking portions 25a of the pair of deformation restrainers 25 are disposed to face each other in a direction orthogonal to the tube axis direction of the corrugated tube 10.

In the pair of deformation restrainers 25, even when the corrugated tube 10 is pulled in the tube axis direction and is narrowed radially inward, the locking portions 25a locks the valley bottom of the valley portion 11B, so that the narrowing amount can be reduced as compared with that in the related art. Therefore, the pair of holding portions 22 and 32 makes it possible to secure the hooking margin of the semi-arcuate portions 24a and 34a in the valley portion 11A at the outer peripheral face. Therefore, the electric wire protection component 1 and the corrugated tube holding structure 100 of the present embodiment can suppress a decrease in the holding force of the corrugated tube 10.

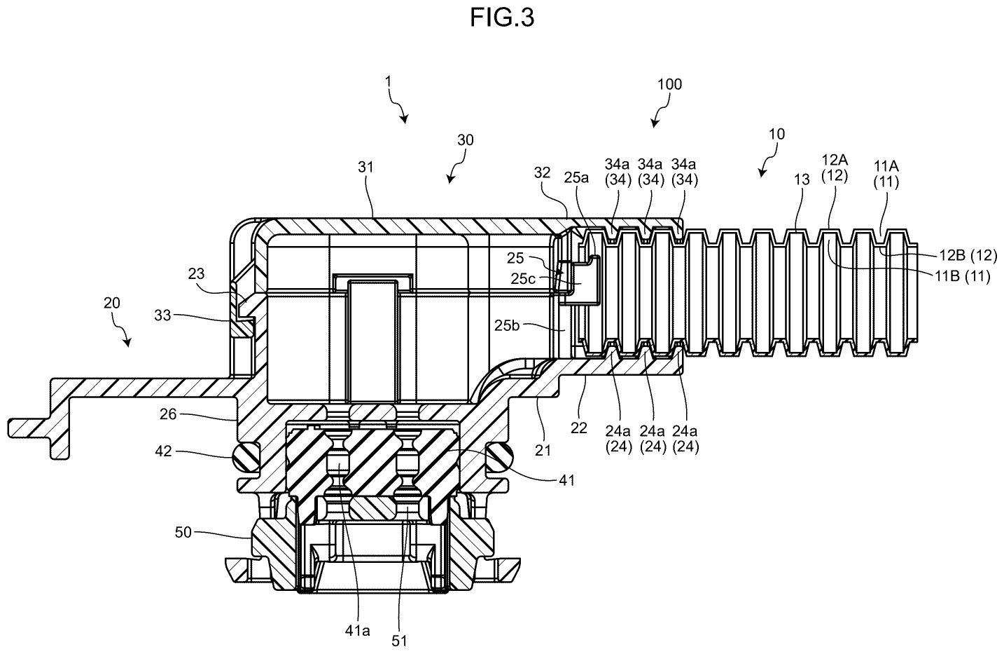

Here, the deformation restrainer 25 further includes a base portion 25b protruding from the inner wall face of the holding portion 22 and disposed to face an end face of the terminal of the corrugated tube 10 in the tube axis direction, and a connection portion 25c connecting the locking portion 25a to the base portion 25b in the terminal of the corrugated tube 10 (FIGS. 3 to 7).

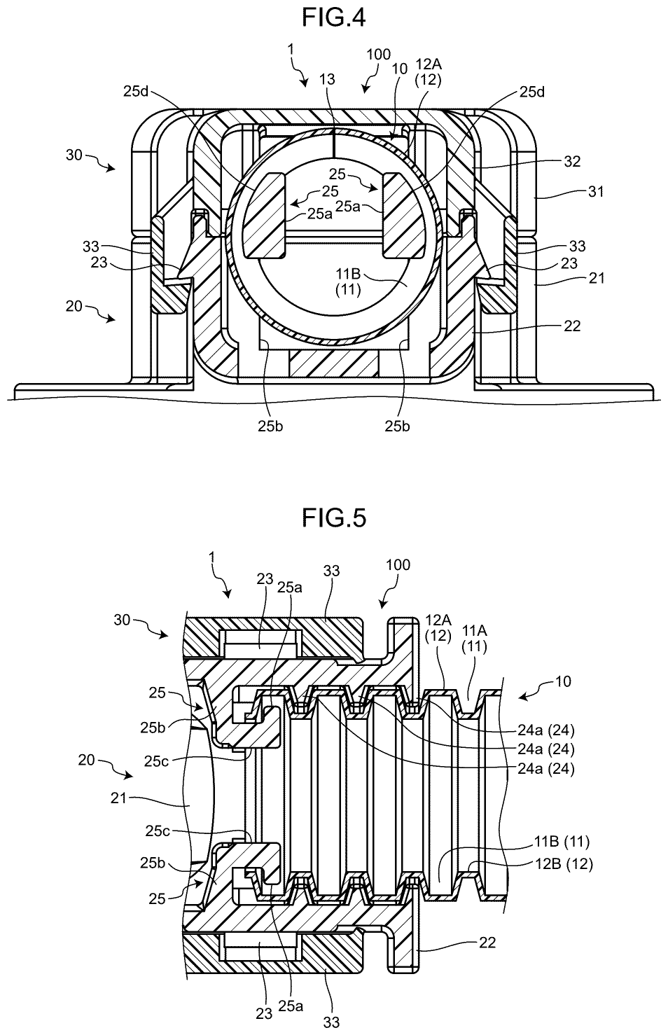

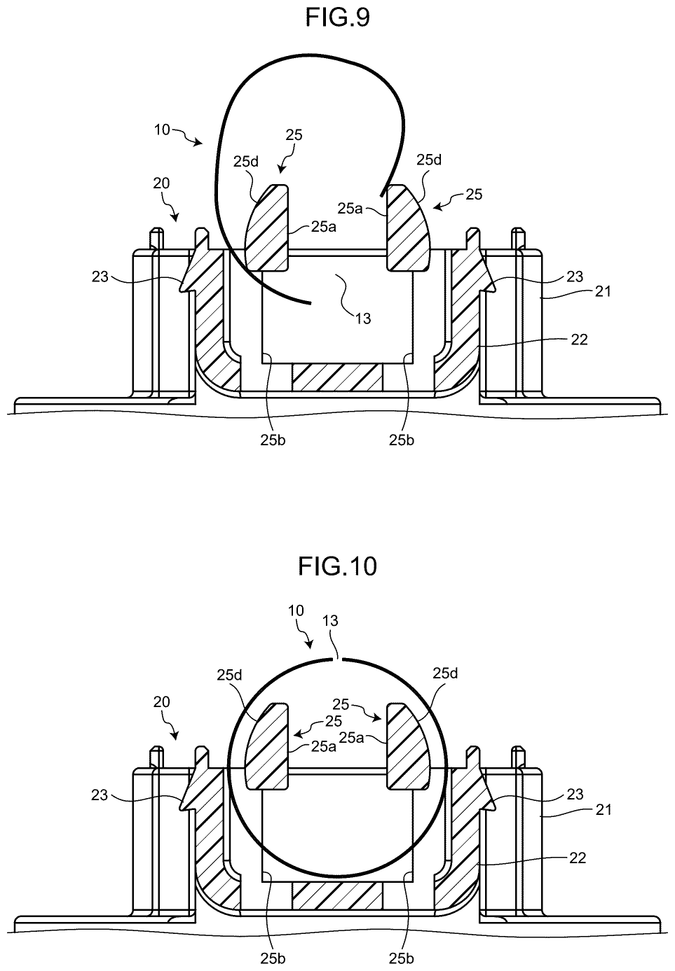

In the holding portion 22, the locking portion 25a of the one deformation restrainer 25 is inserted into the terminal of the corrugated tube 10 from the slit 13, and the locking portion 25a is inserted into the valley portion 11B from one end in the circumferential direction at the slit 13 (FIG. 9). Then, in the holding portion 22, while rotating the corrugated tube 10, one end thereof is guided to the other locking portion 25a of the other deformation restrainer 25. In the holding portion 22, the other locking portion 25a of the deformation restrainer 25 is inserted into the terminal of the corrugated tube 10 from the slit 13, the locking portion 25a is inserted into the valley portion 11B from one end in the circumferential direction at the slit 13, and the corrugated tube 10 is rotated until the slit 13 reaches, for example, between the pair of deformation restrainers 25 (FIG. 10). The locking portion 25a has an arc-shaped face 25d along the arc-shaped bottom face of the valley bottom of the valley portion 11B at the inner peripheral face in order to facilitate the rotation of the corrugated tube 10 (FIGS. 4, 6, and 7).

The locking portions 25a of the pair of deformation restrainers 25 may function as tube expanding portions that expands the terminal of the corrugated tube 10 radially outward in opposite directions against the valley portions 11B at the inner peripheral face to expand the terminal of the corrugated tube 10. As a result, in the pair of holding portions 22 and 32, the narrowing amount when the corrugated tube 10 is pulled in the tube axis direction can be further reduced. Therefore, since the electric wire protection component 1 and the corrugated tube holding structure 100 of the present embodiment can increase the hooking margin of the semi-arcuate portions 24a and 34a in the valley portion 11A, the lowering margin of the holding force of the corrugated tube 10 can be further suppressed.

In the electric wire protection component 1, a plurality of electric wires is pulled out from the corrugated tube 10 whose terminal is held into the internal space of the housing body 21 and the cover body 31 in this manner. The housing 20 includes an electric wire pull-out portion 26 that pulls out the plurality of electric wires in the internal space (FIGS. 1 to 3). The electric wire pull-out portion 26 is formed in a cylindrical shape in which its own cylinder axis is orthogonal to the cylinder axis of the pair of holding portions 22 and 32.

For example, the plurality of electric wires illustrated here connect the torque sensor of the electric power steering and the electronic control device. The electric wire protection component 1 is assembled to a housing of the torque sensor, and is provided to ensure a waterproof function between the electric wire protection component 1 and the housing. In the electric wire protection component 1, the electric wire pull-out portion 26 is fitted into the circular through-hole of the housing.

Therefore, a columnar mat seal 41 provided with a lip on the outer peripheral face is accommodated inside the electric wire pull-out portion 26 (FIG. 3). The mat seal 41 has a cylindrical through hole (hereinafter, referred to as an “electric wire insertion hole”) 41a provided with a lip on the inner peripheral face for each electric wire (FIG. 3). The electric wire pulled out from the terminal of the corrugated tube 10 passes through the internal space formed by the housing body 21 and the cover body 31 and is pulled out through the electric wire insertion hole 41a. In this manner, the mat seal 41 is provided to secure the waterproof function inside the electric wire pull-out portion 26.

In the electric wire protection component 1, a mat seal cover 50 assembled to the electric wire pull-out portion 26 prevents the mat seal 41 from falling off from the electric wire pull-out portion 26 (FIGS. 1 to 3). The mat seal cover 50 has an electric wire insertion hole 51 coaxially with the electric wire insertion hole 41a (FIG. 3). The electric wire passing through the electric wire insertion hole 41a of the mat seal 41 is pulled out through the electric wire insertion hole 51.

An annular seal member 42 is provided on the outer peripheral face of the electric wire pull-out portion 26 (FIGS. 1 to 3). A gap between the outer peripheral face of the electric wire pull-out portion 26 and the inner peripheral face of the through hole in the housing of the torque sensor is filled with the seal member 42, which ensures a waterproof function outside the electric wire pull-out portion 26.

In the corrugated tube holding structure and the electric wire protection component according to the present embodiment, even when the corrugated tube is pulled in the tube axis direction and narrowed radially inward, the respective locking portions lock the valley bottoms of the valley portions at the inner peripheral face, so that the pair of deformation restrainers can reduce the narrowing amount as compared with that in the related art. Therefore, the pair of holding portions makes it possible to secure a hooking margin of the semi-arcuate portion in the valley portion at the outer peripheral face. The corrugated tube holding structure and the electric wire protection component according to the present embodiment can suppress a decrease in the holding force of the corrugated tube.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A corrugated tube holding structure comprising:
a pair of holding members that holds a terminal of a corrugated tube in an assembled state, wherein
the corrugated tube is formed in a bellows tube shape having annular valley portions and crest portions alternately disposed in a tube axis direction, and a slit cut in the tube axis direction,
the pair of holding members includes holding portions that sandwich and hold the terminal of the corrugated tube at an outer peripheral face of the corrugated tube,
the pair of holding portions includes holding ribs provided with semi-arcuate portions concentrically inserted into the valley portions at the outer peripheral face, the each holding rib being a protrusion protruding from an inner wall face toward the outer peripheral face for each of the plurality of valley portions,
one of the holding portions includes a pair of deformation restrainers that protrudes from the inner wall face and suppresses radially inward deformation of the terminal of the corrugated tube,
each of the deformation restrainers includes a locking portion that is inserted into the valley portion of the terminal of the corrugated tube at an inner peripheral face and locks radially inward movement of the terminal of the corrugated tube in the valley portion, and
the locking portions of the pair of deformation restrainers are disposed to face each other in a direction orthogonal to the tube axis direction.

2. The corrugated tube holding structure according to claim 1, wherein
the deformation restrainer includes a base portion protruding from the inner wall face of one of the holding portions and disposed to face an end face of the terminal of the corrugated tube in the tube axis direction, and a connection portion connecting the locking portion to the base portion in the terminal of the corrugated tube.

3. The corrugated tube holding structure according to claim 1, wherein
the locking portion has an arc-shaped face along an arc-shaped bottom face of a valley bottom of the valley portion at the inner peripheral face.

4. The corrugated tube holding structure according to claim 2, wherein
the locking portion has an arc-shaped face along an arc-shaped bottom face of a valley bottom of the valley portion at the inner peripheral face.

5. The corrugated tube holding structure according to claim 1, wherein
the locking portions in the pair of deformation restrainers function as tube expanding portions that expand the terminal of the corrugated tube radially outward in opposite directions against the valley portion at the inner peripheral face to expand the terminal of the corrugated tube.

6. The corrugated tube holding structure according to claim 2, wherein
the locking portions in the pair of deformation restrainers function as tube expanding portions that expand the terminal of the corrugated tube radially outward in opposite directions against the valley portion at the inner peripheral face to expand the terminal of the corrugated tube.

7. An electric wire protection component comprising:
a corrugated tube having annular valley portions and crest portions alternately disposed in a tube axis direction, and a slit cut in the tube axis direction, the corrugated tube having a bellows tube shape through which a plurality of electric wires is inserted;
a housing that accommodates the plurality of electric wires pulled out from a terminal of the corrugated tube and pulls the plurality of electric wires outward; and
a cover that holds the terminal of the corrugated tube with the housing in an assembled state and covers the plurality of electric wires pulled out from the terminal of the corrugated tube with the housing in the assembled state, wherein
the housing and the cover include holding portions that sandwich and hold the terminal of the corrugated tube at an outer peripheral face of the corrugated tube,
the pair of holding portions includes holding ribs provided with semi-arcuate portions concentrically inserted into the valley portions at the outer peripheral face, the each holding rib being a protrusion protruding from an inner wall face toward the outer peripheral face for each of the plurality of valley portions,
one of the holding portions includes a pair of deformation restrainers that protrudes from the inner wall face and suppresses radially inward deformation of the terminal of the corrugated tube,
each of the deformation restrainers includes a locking portion that is inserted into the valley portion of the terminal of the corrugated tube at an inner peripheral face and locks radially inward movement of the terminal of the corrugated tube in the valley portion, and
the locking portions of the pair of deformation restrainers are disposed to face each other in a direction orthogonal to the tube axis direction.
